(19) United States
(12) Patent Application Publication
(10) Pub. No.: US 2015/0197299 A1
(43) Pub. Date: Jul. 16, 2015

(54) BICYCLE TAILLIGHT WITH PARALLEL LIGHTING ELEMENT

(71) Applicant: Specialized Bicycle Components, Inc., Morgan Hill, CA (US)

(72) Inventors: Brian Eric Lee, Corral de Tierra, CA (US); Andreas Absalon Volk, Morgan Hill, CA (US); Ian Hamilton, San Jose, CA (US)

(73) Assignee: Specialized Bicycle Components, Inc., Morgan Hill, CA (US)

(21) Appl. No.: 14/153,916

(22) Filed: Jan. 13, 2014

(51) Int. Cl. B62J 6/04; B62J 1/08; F21V 23/02

(52) U.S. Cl. CPC B62J 6/04; F21V 23/023; B62J 1/08; F21Y 2101/02

(57) ABSTRACT

A bicycle is disclosed comprising wheels, a frame assembly supported on the wheels and including a mounting portion defining a mounting axis, and a lighting system mounted on the mounting portion. The lighting system includes a power source and a lighting element having a lighting axis that is substantially parallel to the mounting axis. Preferably, the mounting axis is at an angle of 70-75 degrees relative to horizontal. The lighting system can further include a primary electronic board positioned substantially parallel to the mounting axis and a secondary electronic board positioned substantially perpendicular to the mounting axis. The lighting element is mounted on the secondary electronic board. The power source is preferably positioned between the primary electronic board and the mounting portion. The lighting system can further comprise a reflector positioned to receive light from the lighting element and direct a majority of the light in a substantially horizontal direction.

### BACKGROUND

The present invention relates generally to the field of bicycles and specifically to bicycle lighting systems.

Many bicycle taillights include mounting brackets to orient the body of the taillight parallel and to the rear of the seat post. Within these taillights, an electronic board is also mounted parallel to the seat post axis, with a cylindrical or prismatic battery cell located between the board and the seat post. On the rear side of the board (opposite the battery) is located an array of light-emitting diodes (LEDs) that generate red light to alert approaching vehicles to the presence of the bicyclist for safety reasons. In some cases, the body of the taillight has a wedge shape to orient the electronic board vertically in order to maximize rearward light projection. However, because LEDs have nearly hemispherical output, many taillights orient the board parallel to the seat post axis to simplify packaging and appearance while sacrificing some light output.

An increasing percentage of taillights available today incorporate higher output “power LEDs” that generate several times as much light output as conventional encapsulated LEDs. These power LEDs are oriented on the rear of the vertical or seat post-angled board and rely on a plastic lens to focus the light output rearward.

### SUMMARY

The present invention provides a bicycle comprising front and rear wheels, a frame assembly supported on the front and rear wheels and including a mounting portion (e.g., a seat post supporting a bicycle seat) defining a mounting axis, and a lighting system mounted on the mounting portion. The lighting system includes a power source and a lighting element (e.g., an LED) powered by the power source and having a lighting axis that is substantially parallel to the mounting axis. Preferably, the mounting axis is at an angle of 65 degrees to 80 degrees (and more preferably 70 degrees to 75 degrees) relative to horizontal.

In one embodiment, the lighting system further includes an electronic board positioned substantially perpendicular to the mounting axis, and the lighting element is mounting on the electronic board. In a specific version of this embodiment, the lighting system comprises a primary electronic board positioned substantially parallel to the mounting axis and a secondary electronic board positioned substantially perpendicular to the mounting axis, and the lighting element is mounted on the secondary electronic board.

The power source is preferably positioned between the primary electronic board and the mounting portion. In addition, the power source can define a power axis that is substantially parallel to the lighting axis.

The lighting system can further comprise a reflector positioned to receive light from the lighting element and direct a majority of the light in a substantially horizontal direction.

Other aspects of the invention will become apparent by consideration of the detailed description and accompanying drawings.

### BRIEF DESCRIPTION OF THE DRAWINGS

FIG. 1 is a perspective view of a bicycle including a lighting system embodying the invention.

FIG. 2 is a side view of the lighting system mounted on a seat post of the bicycle of FIG. 1.

FIG. 2A is a perspective view of the lighting system mounted on the seat post.

FIG. 3 is a perspective view of the lighting system of FIGS. 1 and 2 including a light assembly and a clamp assembly.

FIG. 4 is an exploded perspective view of a portion of the seat post and the lighting system.

FIG. 5 is a section view of the lighting system of FIG. 3 taken along line 5-5.

FIG. 6 is a perspective view of the clamp assembly.

FIG. 7 is an exploded perspective view of the clamp assembly.

FIG. 8 is a section view of the lighting system of FIG. 3 taken along line 8-8.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

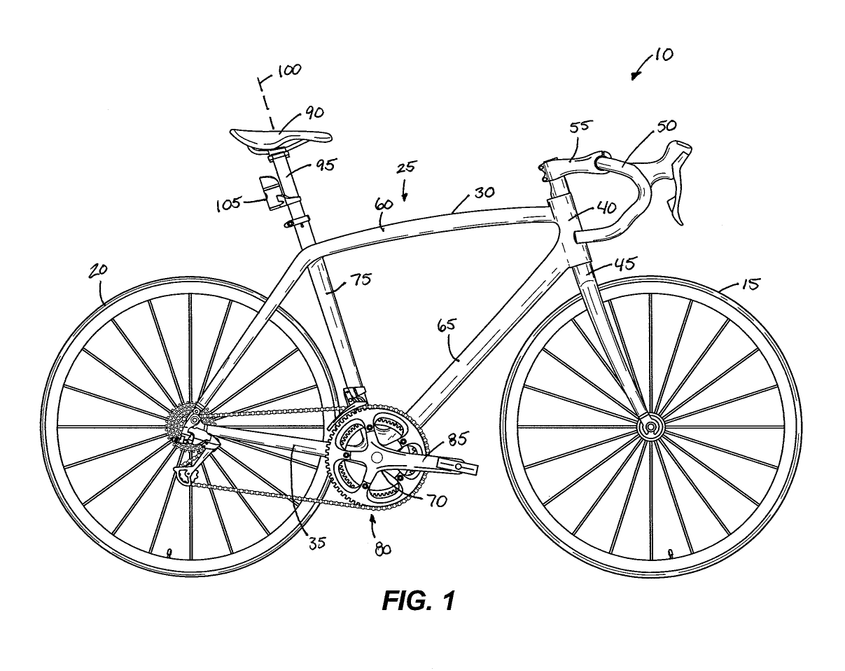

FIG. 1 shows a bicycle 10 (illustrated as a road bicycle) that includes a front wheel 15, a rear wheel 20, and a frame assembly 25 supported on the front and rear wheels 15, 20. The frame assembly 25 is defined by a main frame 30 and a rear frame triangle 35. The main frame 30 has a head tube 40, a front fork 45 rotationally supported by the head tube 40, and a handlebar 50 coupled to the front fork 45 by a stem 55. The main frame 30 also has a top tube 60 connected to and extending rearward from the head tube 40, and a down tube 65 connected to the head tube 40 below the top tube 60 and extending generally downward toward a bottom bracket 70 of the main frame 30. A seat tube 75 extends upward from the bottom bracket 70 and is connected to the top tube 60. The bicycle 10 also includes a drivetrain 80 that has a crankset 85 supported by the bottom bracket 70.

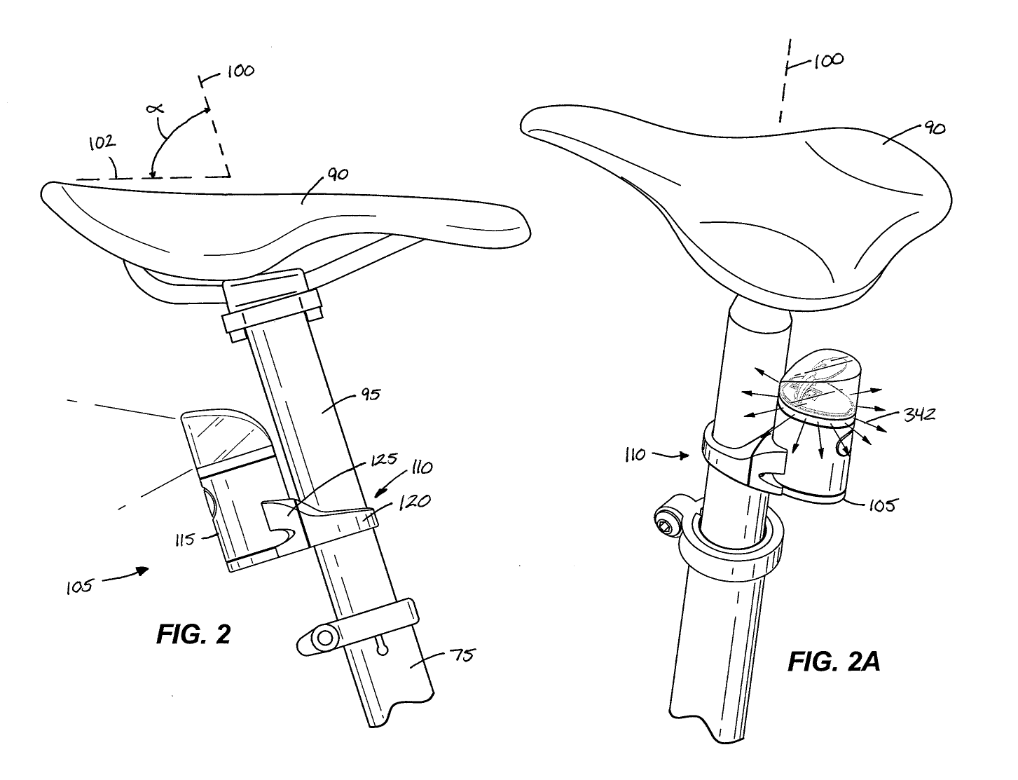

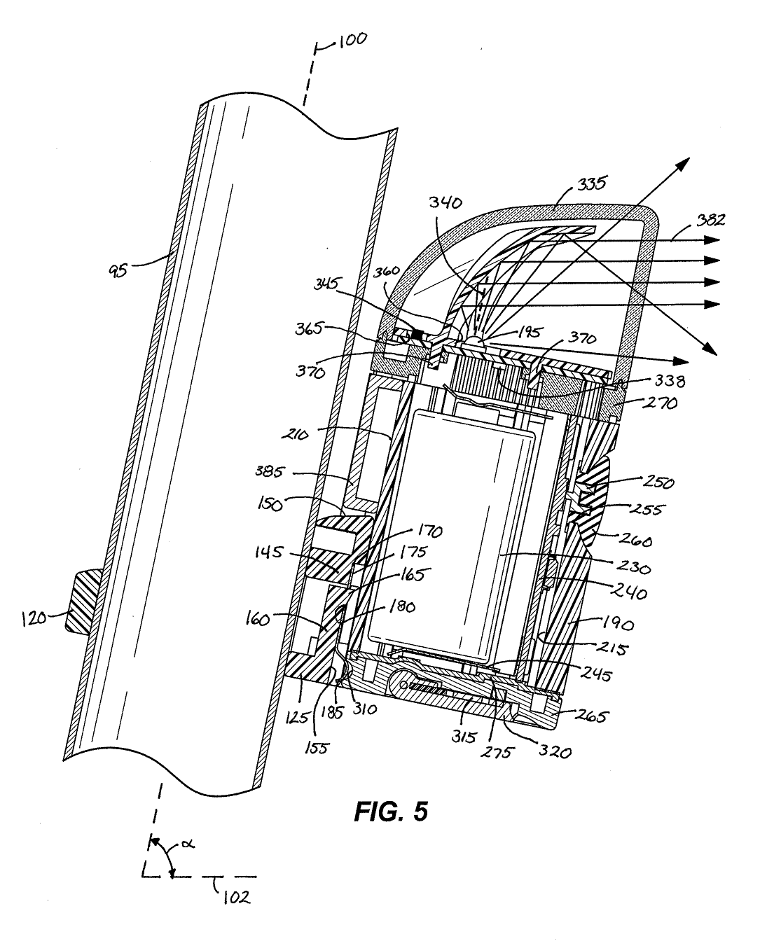

With reference to FIGS. 1-3, the bicycle 10 also includes a seat 90 that is supported by a seat post 95 partially disposed in the seat tube 75. The seat post 95 is adjustable relative to the main frame 30 within the seat tube 75 to adjust the position of the seat 90 relative to the main frame 30. As illustrated in FIGS. 2 and 5, the seat post 95 defines a mounting portion that has a mounting axis 100 extending along the axis of insertion of the seat tube 75. The mounting axis 100 shown in FIGS. 2 and 5 is disposed at an angle a of approximately 65 degrees to 80 degrees relative to horizontal (denoted by a dashed line 102). More specifically, the illustrated mounting axis 100 is disposed at an angle a of approximately 70-75 degrees relative to horizontal, although the seat post 95 can be disposed at other angles relative to horizontal. In some constructions, the mounting portion can be defined by the handlebar 50, the stem 55, the seat tube 75, or another portion of the frame assembly 25.

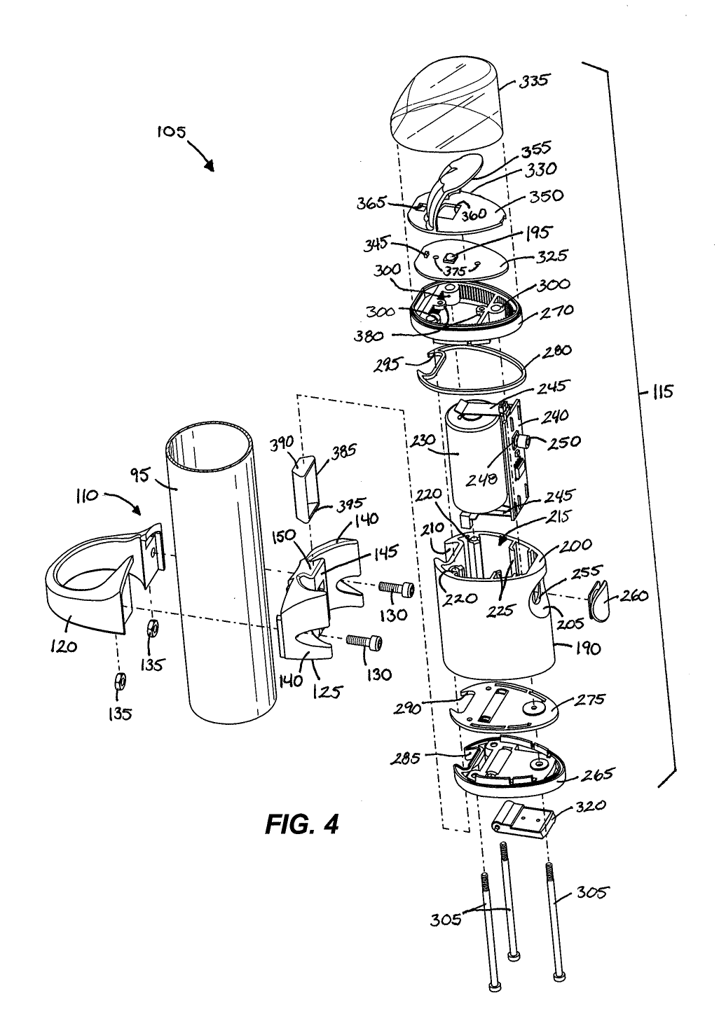

Referring back to FIGS. 1-8, a lighting system 105 is coupled to the bicycle 10. As illustrated, the lighting system 105 is attached to the seat post 95 and is oriented rearward relative to the direction of travel of the bicycle 10 to alert vehicles approaching the bicycle 10 from behind. FIGS. 2-8 show that the lighting system 105 includes a clamp assembly 110 that is attached to the seat post 95, and a light assembly 115 that is supported by the clamp assembly 110. Referring to FIGS. 4-7, The clamp assembly 110 has a first clamp portion 120 generally positioned on a forward side of the seat post 95, and a second clamp portion 125 that is attached to and mates with the first clamp portion 120 (e.g., by fasteners 130). When installed, the first clamp portion 120 surrounds a majority of the mounting portion (e.g., the seat post 95). As illustrated, the first clamp portion 120 also supports nuts 135 that are engageable by the fasteners 130 to secure the two clamp portions 120, 125 together. The illustrated clamp assembly 110 can be provided with several first clamp portions 120 and a single clamp portion 125 to accommodate different-sized seat posts 95. That is, the same rear clamp portion 125 can be used to attach the light assembly 105 to different size seat posts 95 using a front clamp portion 120 that is adequately sized.

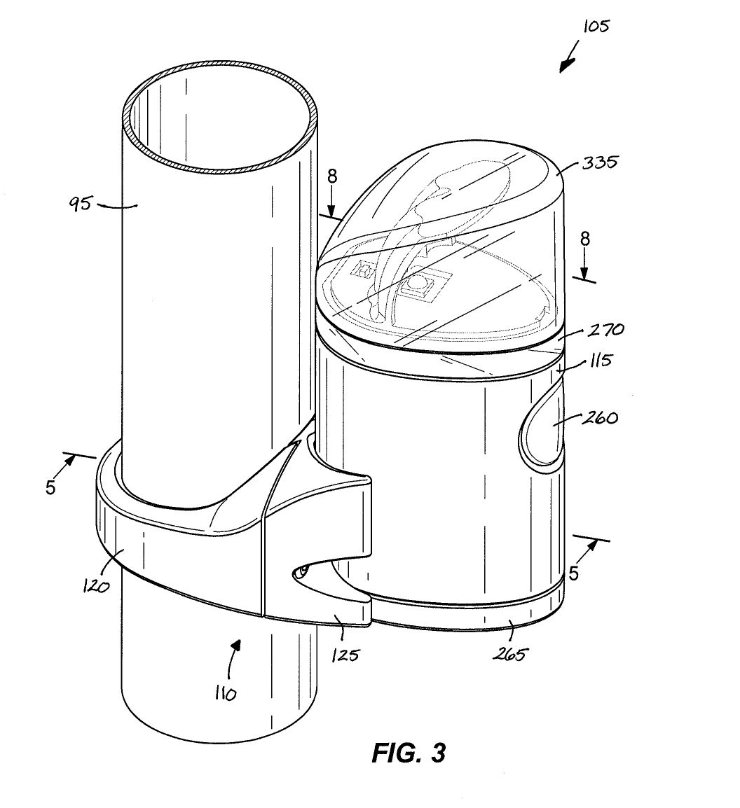

FIGS. 3-7 illustrate that the second clamp portion 125 has flared sections 140 extending laterally outward from a central section 145. The flared sections 140 are curved (rearward relative to the direction of travel) to define a substantially cylindrical receptacle that is shaped to receive the light assembly 115. The central section 145 defines a support post 150 and has a channel 155 disposed below the support post 150. The illustrated channel 155 is slotted along its lateral edges. Referring to FIGS. 5-7, the central section 145 has a wall 160 extending upward from a lower end of the second clamp portion 125. As shown, the wall 160 partially defines the channel 155 and has a distal end that is spaced apart from the upper end of the second clamp portion 125. In some constructions, the wall 160 can flex slightly relative to the remainder of the second clamp portion 125. A protrusion or projection 165 is defined on the wall 160 adjacent the distal end.

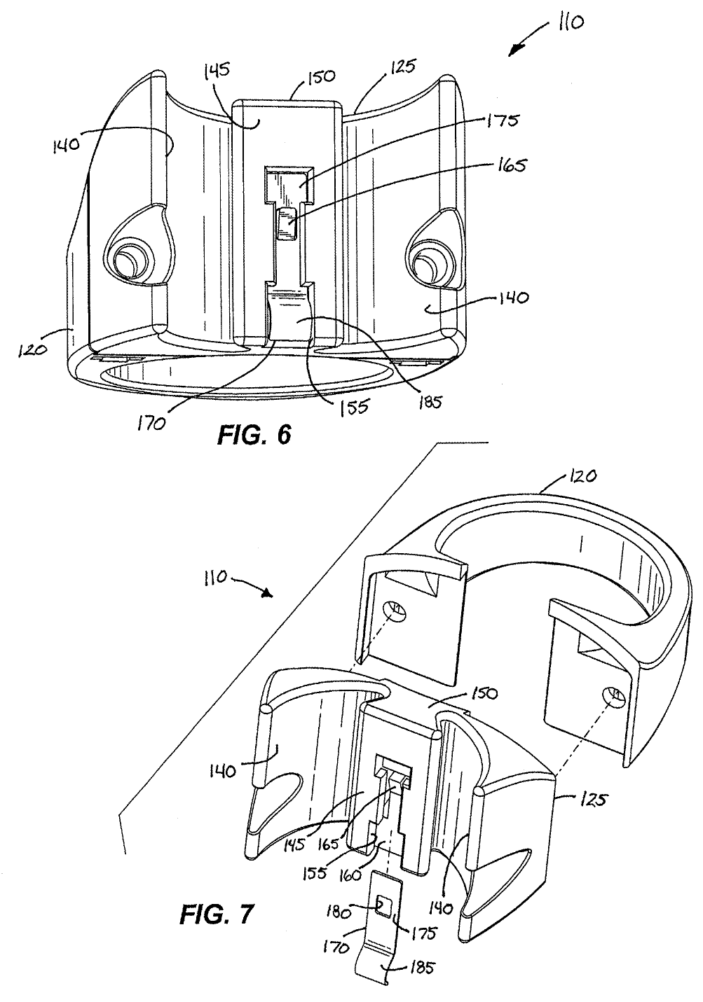

With continued reference to FIGS. 5-7, a spring 170 (e.g., a leaf spring) is secured to the central section 145 within the channel 155. As shown, the spring 170 has a planar portion 175 with a hole 180 through which the projection 165 extends to secure the spring 170 to the second clamp portion 125. FIGS. 6 and 7 illustrate that the planar portion 175 is partially encapsulated along the sides by the part of the central section 145 defining the channel 155. The spring 170 also has a curved portion 185 extending from the planar portion 17. The curved portion 185 has a spring force to removably secure the light assembly 115 to the clamp assembly 110 as described in detail below.

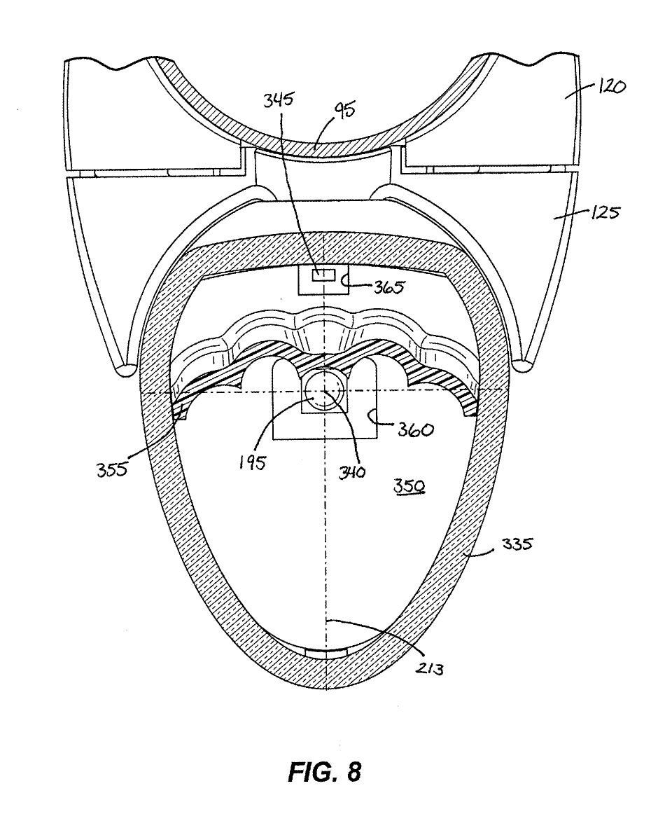

Referring to FIGS. 3-5 and 8, the light assembly 115 includes a housing 190 that supports a lighting element 195. The illustrated housing 190 is defined by an ovular-shaped or egg-shaped body 200 that has a recess 205 disposed on one side of the body 200, and a track channel 210 disposed on another side of the body 200 opposite the recess 205. Described differently, the recess 205 and the track channel 210 are on opposite sides of the housing 190 and are aligned with a major axis 213 of the body 200 when viewed from above (see FIGS. 4 and 8). The central section 145 and the track channel 210 define complementary shapes so that the central section 145 is slidable into the track channel 210 to attach the housing 190 to the second clamp portion 125.

FIG. 4 shows that the housing 190 also defines a cavity 215 and fastener columns 220 extending along the inner side of the body 200 (upward as viewed in FIG. 4). The cavity 215 is partially separated into a first cavity portion and a second cavity portion by walls 225 that extend inward toward each other. The first cavity portion supports a power source 230 (e.g. a rechargeable battery), which has a power axis 235 (FIG. 5). The second cavity portion supports a first or primary electronic board 240 (e.g., a printed circuit board) that is electrically coupled to the power source 230 (e.g., via clips 245). As illustrated, the first electronic board 240 is oriented generally vertically within the housing 190 and is held in place by the walls 225.

Referring to FIGS. 4 and 5, a switch 248 is disposed on the first electronic board 240 and is engageable by a plunger 250 to activate and deactivate the lighting element 195. The switch 248 is accessible via a hole 255 in the housing 190 at the bottom of the recess 205. A button 260 is disposed in the recess 205 and is engageable with (e.g., encapsulates) the plunger 250 (the plunger 250 is illustrated in FIG. 4 as coupled to the switch 248 for illustrative purposes only). The button 260 is resiliently manipulatable and acts on the plunger 250 to selectively provide power to the lighting element 195 from the power source 230 by varying the switch 248 between on and off states.

With continued reference to FIGS. 4 and 5, light assembly 115 also includes a bottom cap 265, a light ring 270, a bottom gasket 275 secured to the housing 190 by the bottom cap 265, and a top gasket 280 secured to the housing 190 by the light ring 270. As illustrated, the bottom cap 265 has a first track recess 285 that is aligned with the track channel 210 adjacent a lower side of the housing 190. The bottom gasket 275 has a second track recess 290 aligned with the track channel 210 and the first track recess 285. The top gasket 280 has a third track recess 295 that is aligned with the track channel 210 adjacent the upper side of the housing 190. The track channel 210 and the track recesses 285, 290, 295 and the central section 145 are shaped complementary to each other to secure the light assembly 115 to the clamp assembly 110 as described in detail below.

The light ring 270 is shaped to conform to the shape of the upper side of the housing 190. The light ring 270 is transparent or translucent (clear or colored red, for example) and defines a refractory that directs light to the sides and front of the light assembly 115. More specifically, the light ring 270 has a prismatic internal shape to maximize light diffusion. As shown in FIG. 4, the light ring 270 has fastener attachments 300 (e.g., brass fasteners ultrasonically welded into the light ring 270, heat staked, mechanically installed, etc.). The bottom cap 265 and the light ring 270 are attached to the housing 190 by fastener bolts 305 extending through the bottom cap 265 and the light ring 270, within the fastener columns 220 of the housing 190, through the bottom and top gaskets 275, 280, and into the fastener attachments 300. The bottom gasket 275 seals a lower side of the housing 190 (e.g., from moisture, debris, etc.), and the top gasket 280 seals an upper side of the housing 190.

The bottom cap 265 has a detent or depression 310 formed in the wall defining the first track recess 285. The depression 310 is engageable by the spring 170 to resist removal of the light assembly 115 from the clamp assembly 110. The bottom cap 265 also supports an externally accessible electrical input 315 that is enclosed by a pivotable cover 320 (e.g., designed to fit into a standard Universal Serial Bus or “USB” socket). The bottom cap 265 and the bottom gasket 275 cooperatively define an electrical connection or pathway between the electrical input 315 and the power source 230 (e.g., via the first electronic board 240) to charge the power source 230.

FIGS. 4, 5, and 8 show that the light assembly 115 also includes a secondary electronic board or light board 325 (referred to herein as the “light board 325” for purposes of description), a reflector 330, and a lens 335. The light board 325 is coupled to the light ring 270 substantially flush with a top of the light ring 270. The illustrated light board 325 supports the lighting element 195 and one or more secondary light elements 338. The lighting element 195 is illustrated as a light emitting diode (“LED”) chip or light source, although the lighting element 195 can be a different light source. Generally, the lighting element 195 can be a power LED that outputs a relatively high amount of light, and the secondary light elements 338 can be smaller (e.g., non-power) LED lights that output a smaller amount of light. The light board 325 can support more than one lighting element 195 and one or more light elements 338.

The lighting element 195 and the secondary light elements 338 are electrically coupled to and powered by the power source 230. With reference to FIG. 5, the lighting element 195 is oriented generally upward and has a lighting axis 340 along which generated light primarily emanates (see FIG. 5). The secondary light elements 338 are positioned on the underside of the light board 325 and are oriented so that light emanates along the lighting axis 340 in a direction opposite the direction of light from the lighting element 195. The light from the secondary light elements 338 is further projected through the light ring 270 substantially in all directions as indicated by arrows 342 (forward, rearward, and to the sides of the bicycle 10 relative to the direction of travel for the bicycle 10).

The light board 325 is oriented perpendicular to the first electronic board 240 and has a tertiary light (e.g., LED) 345 that is positioned adjacent an edge of the light board 325. The illustrated tertiary light 345 is an “upfiring” LED (oriented upward on the board 325 as viewed in FIG. 5) that provides some illumination toward the front of the bicycle 10 and that also can function as an ambient light sensor (e.g., to turn on the light assembly 115).

The base 350 acts as a top cap for the light assembly 115. Referring to FIGS. 4, 5, and 8, the base 350 has a first aperture 360 through which the lighting element 195 is exposed, and a second aperture 365 that is aligned with the alignment projection 345 so that the reflector 330 rests on the light board 325 and can be attached to the light ring 270 (e.g., snap-fit, adhered, etc.). As shown in FIG. 5, the base 350 has downwardly extending columns 370 (i.e. alignment features) that frictionally engage corresponding holes 375 defined in the light board 325 and column supports 380 defined by the light ring 270. Although not shown, the light board 325 can be attached to the light ring 270 in other ways (e.g., fasteners, snap-fit arrangement, adhesive, etc.).

The illustrated reflector element 355 is co-formed (e.g., co-molded, extruded, etc.) with the base 350, although the reflector element 355 can be separately attached to the base 350. The reflector element 355 extends or curves generally upward from the base 350 to form a canopy that can reflect light (denoted by arrows 382 in FIG. 5) from the lighting element 195 outward from the light assembly 115. As shown in FIG. 8, the illustrated reflector element 355 at least partially encloses three sides of the lighting element 195 to direct light in a desired direction (e.g., generally rearward relative to the direction of bicycle travel when mounted on the seat post 95). The illustrated reflector element 355 has a corrugated or waveform shape that curves above the lighting element 195 and around the lighting element 195 (with a vertex on or near the lighting axis 340) on three sides to primarily focus light emanating from the lighting element 195 in the desired direction. In other constructions, the reflector element 355 can have a planar shape, a continuously curved shape, or another shape in cross-section. The illustrated reflector element 355 is formed of molded plastic that has a vacuum metalized coating, although the reflector element 355 (and in some cases, the base 350 as well) can be formed of polished aluminum or from other highly reflective material so that light from the light source can be redirected outward.

The lens 335 is coupled to the light ring 270 (e.g., snapped onto or adhered) to protect the lighting element 195 and the secondary light elements 338 from moisture and debris. The lens 335 can be clear or colored (e.g., red). As illustrated, the lens 335 is shaped to conform or taper in the direction that the reflector element extends, although other shapes are possible and considered herein.

With continued reference to FIGS. 4 and 5, a stop member 385 is slidable into the track channel 210 and the track recesses 185, 190, 195 to support the housing 190 on the support post 150. The track channel 210 and the stop member 385 have complementary shapes such that the stop member 385 frictionally engages the track channel 210. An upper wall 390 of the stop member 385 is positioned near or is engaged with the bottom side of the light ring 270. A lower wall 395 of the stop member 385 is spaced (upward) from the lower end of the housing 190 such that when the light assembly 115 is attached to the clamp assembly 110, the lower wall 395 is engaged with the support post 150. The stop member 385 can be resilient so as to deform slightly when downward pressure is exerted on the light assembly 115 during attachment so that the spring 170 can snap into engagement with the bottom cap 265 within the depression 310. As illustrated, the stop member 385 acts as a spacer to limit downward movement of the light assembly 115 relative to the clamp assembly 110 after the spring 170 snaps into the depression 310. In the spring-engaged position, the bottom cap 265 is flush with the bottom of the clamp assembly 110.

To assemble the illustrated lighting system 105, the first clamp portion 120 and the second clamp portion 125 are oriented around the seat post 95 and secured to each other using the fasteners 130. The spring 170 can be attached to the second clamp portion 125 at any time prior to attachment of the light assembly 115 to the clamp assembly 110. In particular, the planar portion 175 of the spring 170 is aligned with the opening to the channel 155 and slid upward into the channel 155. The sides of the channel 155 restrict movement of the spring 170 outward from the channel 155 (i.e. in a direction perpendicular to the direction of spring insertion). The projection 165 flexes slightly due to engagement of the planar portion 175 with the wall 160 and the sides of the channel 155. The planar portion 175 may also flex slightly. Continued upward movement of the spring 170 within the channel 155 aligns the hole 180 with the projection 165, which projects through the hole 180 when the spring 170 is fully inserted into the channel 155. As illustrated, the spring 170 is held in place by the sides of the channel 155 and by the engagement between the projection 165 and the hole 180.

To assemble the light assembly 115, the button 260 is engaged with the hole 255 and the plunger 250 is positioned on the inside or outside of the housing 190 and engaged with the button 260 adjacent the hole 255. The power source and the first electronic board 240 are slid into the housing 190 within the cavity 215. The first electronic board 240 is aligned with the plunger 250 so that the plunger 250 can engage the switch 248.

Next, the reflector 330 is held upside down and the light board 325 is placed onto the base 350 so that the columns 370 pass through the holes 375. The light ring 270 is placed on the light board 325 so that the columns 370 pass through the column supports 380. The ends of the columns 370 can be deformed with heat (e.g., from an iron) to hold the sub-assembly of the reflector 330, the light board, and the light ring 270. The lens 335 is placed over the reflector element 355 and the components of the sub-assembly are secured (e.g., ultrasonically welded together, adhered, or attached by snap-fit arrangement) to each other.

The top gasket 280 is placed into a groove in the sub-assembly of the reflector 330, the light board 325, and the light ring 270. Thereafter, the sub-assembly is positioned on top of the housing 190. The bottom gasket 275 is fitted into a groove in the bottom cap 265. The bottom cap 265 and the bottom gasket 275 are positioned below the body, and the fasteners 305 are inserted through the bottom cap 265, the fastener columns 220, and into the fastener attachments 300 within the reflector sub-assembly, and then tightened to secure the light assembly 115 together. The stop member 385 is inserted from below the housing 190 through the track recesses 185, 190, 195 and into engagement with the track channel 210.

The light assembly 115 is removably secured to the clamp assembly 110 by aligning the opening to the track channel 210 with the central section 145 and lowering the light assembly 115 onto the second clamp portion 125 until the stop member 385 is near or is engaged with the support post 150. In this position, the spring 170 is engaged with the depression 310 to resist further movement of the housing 190 relative to the second clamp portion 125.

When the light assembly 115 is attached to the clamp assembly 110 on the seat post 95, each of the first electronic board 240 and the lighting axis 340 of the lighting element 195 is oriented parallel or substantially parallel (e.g., within a 0-5 degrees of parallel) to the mounting axis 100. The light board 325 is oriented perpendicular or substantially perpendicular (e.g., within 0-5 degrees relative to perpendicular) to the mounting axis 100. Also, the power source 230 is positioned between the first electronic board 240 and the seat post 95, and the power axis 235 is substantially parallel to the lighting axis 340.

Light (arrows 382) from the lighting element 195 is directed along the lighting axis 340, which is substantially parallel to the mounting axis 100. A portion of the light is directed directly through the lens 335 into the surrounding environment. A substantial portion (i.e. a majority) of the light is received and redirected by the reflector element 355 in a substantially horizontal direction (e.g., horizontal, or within 10 degrees of horizontal). When the light assembly 115 is mounted on the seat post 95, a majority of the light is directed rearward (e.g., to warn oncoming vehicles) relative to the direction of travel, although some light is directed toward the sides of the bicycle 10. Also, some light from the secondary light elements 338 is directed sideways and forward relative to the direction of travel such that light is visible from the rear, sides, and generally forward of the bicycle 10. The light ring 270 has a prismatic internal shape to maximize light diffusion from the side-firing light elements 338 to ensure that light from the lighting element 195 and the light elements 338 is distributed in a nearly 360 degree circle, shadowed only by the seatpost 95 and the rider's legs.

The lighting system 105 can be mounted to the seat post 95, the handlebar 50, or another part of the frame assembly 25. In the illustrated construction, light emanates from the light assembly 115 at an obtuse angle (e.g., approximately 100-120 degrees) so that more light is captured and redirected to send more light rearward. In some constructions, the light assembly 115 can be attached to the clamp assembly 110 so that the lighting element 195 is positioned below the housing 190. In this position, the reflector 355 will be shaped differently to redirect light in a more acute angle (e.g., 60-80 degrees). With the illustrated seat post 95, the acute angle would be approximately 72 degrees.

The lighting system 105 can accommodate different-sized and/or shaped (e.g., oval, circular, or teardrop seat posts 95) by using the same second clamp portion 125 with a different-sized first clamp portion 120. In this manner, the clamp assembly 110 is generally universal with few additional components needed to accommodate different sizes.

Regardless of the location or the position of the lighting system 105, the orientation of the light board 325 relative to the mounting axis 100 directs light generally parallel to the mounting axis 100. The reflector 330 is shaped to enhance light output by reflecting a majority of the light in a horizontal, rearward direction even though the angle a defined by the mounting axis 100 (or the lighting axis 340) relative to horizontal is less than 90 degrees (or more than 90 degrees if the lighting element 195 is positioned below the housing 190). The reflector 330 can be shaped to tailor light output (e.g., to create a focused or more diffused light pattern) from the lighting element 195 so that light is directed substantially horizontally even when the light board 325 is oriented at a non-zero angle relative to horizontal (e.g., perpendicular to the mounting axis 100).

Various features of the invention are set forth in the following claims.

1. A bicycle comprising:
front and rear wheels;
a frame assembly supported on the front and rear wheels and including a mounting portion defining a mounting axis; and
a lighting system mounted on the mounting portion, the lighting system including a power source and a lighting element powered by the power source, the lighting element having a lighting axis that is substantially parallel to the mounting axis.

2. A bicycle as claimed in claim 1, further comprising a seat, wherein the mounting portion comprises a seat post supporting the seat.

3. A bicycle as claimed in claim 2, wherein the frame assembly further includes a main frame, wherein a position of the seat post is adjustable relative to the main frame.

4. A bicycle as claimed in claim 1, wherein the mounting axis is at an angle of 65 degrees to 80 degrees relative to horizontal.

5. A bicycle as claimed in claim 4, wherein the mounting axis is at an angle of 70 degrees to 75 degrees relative to horizontal.

6. A bicycle as claimed in claim 1, wherein the lighting system further includes an electronic board positioned substantially perpendicular to the mounting axis, and wherein the lighting element is mounted on the electronic board.

7. A bicycle as claimed in claim 6, wherein the lighting element comprises an LED.

8. A bicycle as claimed in claim 6, wherein the lighting element is positioned on a top side of the electronic board.

9. A bicycle as claimed in claim 1, wherein the lighting system comprises a primary electronic board positioned substantially parallel to the mounting axis and a secondary electronic board positioned substantially perpendicular to the mounting axis, and wherein the lighting element is mounting on the secondary electronic board.

10. A bicycle as claimed in claim 9, wherein the power source is positioned between the primary electronic board and the mounting portion.

11. A bicycle as claimed in claim 1, wherein the lighting system further comprises a reflector positioned to receive light from the lighting element and direct a majority of the light in a substantially horizontal direction.

12. A bicycle as claimed in claim 1, wherein the power source defines a power axis that is substantially parallel to the lighting axis.

13. A bicycle lighting system comprising:
a mounting portion adapted to be coupled to a bicycle, the mounting portion defining a mounting axis;
a housing secured to the mounting portion;
a power source positioned in the housing; and
a lighting element powered by the power source, the lighting element having a lighting axis that is substantially parallel to the mounting axis.

14. A bicycle lighting system as claimed in claim 13, further comprising an electronic board positioned substantially perpendicular to the mounting axis, and wherein the lighting element is mounting on the electronic board.

15. A bicycle lighting system as claimed in claim 14, wherein the lighting element comprises an LED.

16. A bicycle lighting system as claimed in claim 13, wherein the lighting system comprises a primary electronic board positioned substantially parallel to the mounting axis and a secondary electronic board positioned substantially perpendicular to the mounting axis, and wherein the lighting element is mounted on the secondary electronic board.

17. A bicycle lighting system as claimed in claim 16, wherein the power source is positioned between the primary electronic board and the mounting portion.

18. A bicycle lighting system as claimed in claim 13, further comprising a reflector positioned to receive light from the lighting element and direct a majority of the light in a direction that is 65 degrees to 80 degrees offset from the lighting axis.

19. A bicycle lighting system as claimed in claim 18, wherein the reflector is positioned to direct a majority of the light in a direction that is 70 degrees to 75 degrees offset from the lighting axis.

20. A bicycle lighting system as claimed in claim 13, wherein the power source defines a power axis that is substantially parallel to the lighting axis.
